(19) United States
(12) Patent Application Publication
(10) Pub. No.: US 2005/0018418 A1
(43) Pub. Date: Jan. 27, 2005

(54) Internally illuminated fishing rod

(76) Inventors: Darrell S. Keith, Dawsonville, GA (US); Christopher D. Chechele, Alpharetta, GA (US)

Correspondence Address: GREGORY SCOTT SMITH, P.O. BOX 88148, ATLANTA, GA, 30356, US

(21) Appl. No.: 10/627,157

(22) Filed: Jul. 25, 2003

(51) Int. Cl. F21V 33/00

(52) U.S. Cl. 362/109

(57) ABSTRACT

An illuminated fishing rod, suitable for night fishing, comprising a hollow core and a light source positioned within one end of the hollow core and the light waves from the light source being directed towards the opposite end of the hollow core. The light waves are directed external to the rod by various means including a tapered hollow core, light refractors and other abrasions. The power source for the light source can be located internal to a handle portion.

### FIELD OF THE INVENTION

This invention is related to the field of angling equipment and, more particularly, to a fishing rod having an illumination source to assist in identifying rod location and movement during nighttime fishing.

### BACKGROUND OF THE INVENTION

Although very few young sports fans could blurt out the name of the 2002 World Champion Billfish Angler Garvan McColgan, and although you may never see a Nike commercial featuring Kevin VanDam, America's most revered bass fisherman with nearly $1.5 million in winnings, three B.A.S.S Angler of the Year awards, an FLW Tour Angler of the Year Crown and the title of the 2001 BASS Master Classic, fishing has, remains, and will continue to be a great sport and recreational activity.

One typically pictures the fishing scene as boys standing on a bridge or pier, bass boats nestled underneath tree branches in a tributary of a lake, or anglers dressed in rubber boots that come up to their chests as they wade through an icy river, snapping their lines in the air. When you picture these scenes, the one common thread will most likely be that each scene includes the sun shining brightly in a blue sky. However, there is a whole world of fishing that does not typically make it onto the fishing shows aired by ESPN—this is the world of night fishing.

There are countless of reasons why night fishing is such an increasingly popular sport. A few such reasons include the reduction in boat traffic (especially recreational) during the night, work and family schedules being too hectic to get away during the daylight and the desire to take advantage of the cooler temperatures at night. However, the serious anglers know that during the nighttime hours, the angler can gain certain advantages over his or her prey. For instance, when fishing during the daylight, the angler must adjust his or her fishing to deeper water as hot surface temperatures tend to send the fish to deeper waters where there is food and good dissolved oxygen. However, with night fishing, the fish tend to come closer to the cooler surface of the water. Another huge advantage in night fishing is that fish are naturally drawn to shiny items and lights. Although banned in some states, usually those that have decreasing fish populations, many nighttime anglers engage in “green light” fishing. This helps to make the fishing experience more exciting and, more importantly, more fruitful.

Along with the joy of fishing at night comes a host of problems that arise primarily due to the well known fact that for us mortal human beings, it is certainly more difficult to see at night than it is during the daylight. Several developments in angling equipment have been introduced to alleviate this inconvenience. Such developments include lighted tackle boxes, safety equipment to alert others of your position, equipment that glows in the dark, and various illumination devices that attach to, or operate in conjunction with a fishing rod.

One prevalent problem that will quickly become apparent to anyone on their first nighttime angling excursion is the inability to see the fishing rod and, more importantly, to see when the fishing rod is moving due to action at the other end of the fishing line. Several techniques have been introduced in an attempt to alleviate this problem; however, none of these techniques fully resolve the problem and, in some instances actually result in creating other problems. For instance, some of the available illuminating techniques for fishing rods are plagued by pitfalls, such as (a) attracting insects, (b) being bulky and cumbersome to install and/or operate, (c) creating a risk of entanglement of the fishing line, and/or (d) adversely effecting the breakdown and storage of the fishing rod.

Thus, there exists a need in the art for a technique to provide illumination to a fishing rod that is immune to these, as well as other problems. The present invention provides such a solution and, the manner by which this invention exhibits these advantages will become more apparent in the description which follows, particularly when considered in conjunction with the accompanying drawings.

### SUMMARY OF THE INVENTION

The present invention provides a solution to the afore-mentioned problems with relationship to the illumination of a fishing rod. The present invention can be included in various embodiments but in general, operates to provide illumination across the entire length of the rod, or portions of the rod across the length of the rod, and exists completely internal to the rod.

In one embodiment of the present invention, all or portions of the rod material is manufactured with transparent or translucent material. As an example, the rod can be constructed from a clear epoxy resin to provide the translucent characteristic for light transmission throughout its entire length. The typical fishing rod includes a hollow core that is tapered from the base end to the tip. The hollow core of such a fishing rod is also tapered resulting in the core at the base having a larger diameter than the core at the tip. In this embodiment of the invention, a light source is placed at the interior base of the rod and the light is directed up the hollow core towards the tip. The tapered core results in refracting the light waves in a manner that light waves exit through the transparent or translucent material and thus, illuminates the rod. This embodiment of the invention is particular advantageous in that when the rod is moved, as is typical when a fish is attacking the bait on the end of the fishing line, the refraction of the light waves will be altered and thereby providing a visible indication of the activity.

This embodiment of the invention is directed to a fully lighted fishing rod that is capable of producing a unique light reflecting and refracting pattern throughout the length of the tapered hollow rod or shaft and advantageously alleviates the afore-mentioned problems pertaining to nighttime fishing.

In another embodiment of the invention, all or portions of the rod material is manufactured with transparent or translucent material. A light source is placed at the interior base or tip of the rod and the light is directed respectively up the hollow core towards the tip or down the hollow core towards the base. Internal to the rod, light wave obstructions or refractors are placed in a manner to alter light waves by refracting them external to the rod and thereby providing illumination to portions of the rod.

In another embodiment of the invention, a tube or light conductor is placed internal to the rod and serves as a conduit for the light source. The tube can have the taper characteristic similar to the core and rod or may employ the use of light obstructions or refractors.

In another embodiment, a series of mini light sources are mounted internal to the rod at various locations.

Accordingly, embodiments of the present invention operate to provide a fully or partially illuminated fishing rod, and thereby alleviate or eliminate the problems in the prior art techniques by enabling a fisherman to see the fishing rod while fishing at nighttime.

These and other features of the invention will become more apparent from the following specification, particularly when read in conjunction with the accompanying drawings.

### BRIEF DESCRIPTION OF DRAWINGS

FIG. 1 is a side view of a typical fishing rod suitable for incorporating the unique features of the various embodiments of the present invention.

FIG. 2a illustrates an alternative embodiment of the present invention that utilizes angled light refractors within the hollow core of the rod.

FIG. 2b illustrates an alternative embodiment of the present invention that utilizes upright light refractors within the hollow core of the rod.

FIG. 3 is a diagram illustrating the provision of a light source in an embodiment in which the light source is located in the base end of the rod and directed towards the tip end of the rod.

### DETAILED DESCRIPTION OF EMBODIMENTS OF THE INVENTION

The various embodiments of the present invention provide a solution to the afore-mentioned problems with relationship to the illumination of a fishing rod by operating to provide internal illumination to the fishing rod. The present invention can be included in various embodiments but in general, operates to provide illumination across the entire length of the rod, or portions of the rod across the length of the rod, and is completely internal to the rod.

Turning now to the figures in which like references represent like elements throughout the several views, the various embodiments of the invention will now be described.

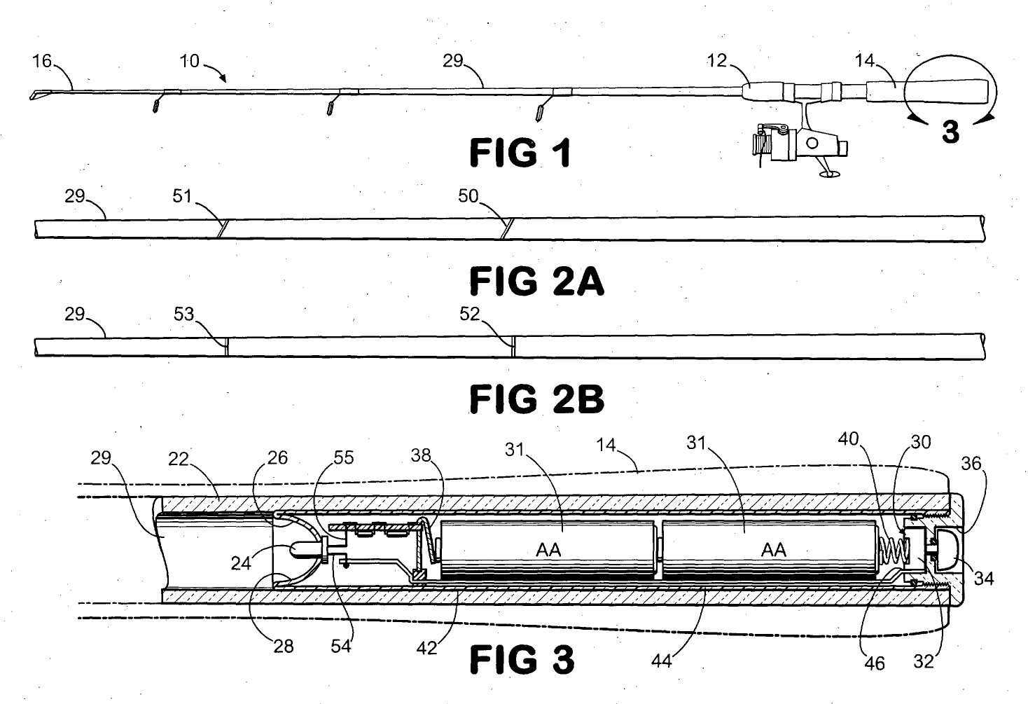

FIG. 1 is a side view of a typical fishing rod suitable for incorporating the unique features of the various embodiments of the present invention. The illustrated fishing rod 10 includes a base end 12 and a tip end 16. The rod 10 includes an internal hollow core 29 extending from the base end 12 to the tip end 16. In some embodiments of the invention, the hollow core 29 is tapered in a manner that the diameter of the hollow core 29 at the base end 12 is larger than the diameter at the tip end 16.

A key aspect of the present invention is the illumination of the rod 10, or portions of the rod 10 extending between the base end 12 and the tip end 16. This aspect of the invention can be provided using several techniques; however, the common feature among the various embodiments of the invention is that a light source is internal to the rod 10 and the rod 10 is illuminated by refracting and reflecting the light waves provided from the light source in such a manner as to illuminate all or portions of the rod 10.

The rod 10 is preferably composed of a light transmitting, translucent, fiber glass, epoxy resin material that is flexible, or alternatively, a composite of fiberglass/graphite. For illustrative purposes only, an exemplary rod 10 can be constructed to have hollow core 29 with a diameter of about ½″ at the base end 12, tapering down to a diameter of about 1/16″ at the tip end 16, and a generally uniform wall thickness of from about 1/64″ to 1/16″.

The overall length may be between about 7 to 7½ feet. The rod 10 can be constructed or fabricated around a mandrel, then withdrawn to reveal a hollow core 29 throughout its length; however, those skilled in the art will appreciate that other techniques can be used to fabricate a rod 10 suitable for the various embodiments of the present invention.

In one embodiment of the present invention, a light source is placed at the base end 12 of the rod 10 and the light waves are directed through the hollow core 29 towards the tip end 16. Snell's law is well known in the art and basically states that as light waves pass from a first medium into a second medium, the light waves will be refracted. The amount of refraction will depend on the light conducting characteristics of the two mediums. In the present embodiment of the invention, the air within the hollow core operates as a first medium and the rod 10 operates as the second medium. The tapering shape of the rod's internal core 29 operates to continuously change the incident angle at which light rays strike the internal surface. Rather than freely traveling down the rod, the light rays are refracted outward, producing a glowing appearance distributed down the length of the rod 10.

Advantageously, this embodiment of the present invention allows an observer to determine when activity is occurring on the fishing line. For instance, when the rod tip end 16 is deflected even slightly, such as from fish bites and nibbles, the refraction of the light waves within the hollow core 29 will be altered. As a result, the light will appear to flicker on and off due to the changing internal incident light ray angles. Thus, the flickering rod serves as an alert device signaling line/pole activity.

Although the natural refraction characteristics of a tapered hollow core 29 provide a preferred embodiment for the present invention, the present invention is not limited to such a configuration. In fact, the present invention anticipates other embodiments that can also provide refractive characteristics to the light waves traveling through the hollow core 29 of the rod 10. FIG. 2a illustrates an alternative embodiment of the present invention that utilizes angled light refractors within the hollow core of the rod. In this embodiment of the invention, transparent light refractors 50 and 51 are placed within the hollow core 29 of the rod 10 at an angle position. Although for illustrative purposes, only two such light refractors are shown, any number of such refractors could be included internal to the rod 10. In operation, as the light waves travel through the hollow core 29 of the rod 10, they strike the light refractors 50 and 51. A portion of the light waves travel through the light refractors 50 and 51, and a portion of the light waves are refracted towards the wall of the hollow core 29 and thus, exit the rod 10 to provide illumination.

FIG. 2b illustrates an alternative embodiment of the present invention that utilizes upright light refractors within the hollow core of the rod. In this embodiment of the invention, transparent light refractors 52 and 53 are placed within the hollow core 29 of the rod 10 at an upright position, or substantially perpendicular to the walls of the hollow core 29. Although for illustrative purposes, only two such light refractors are shown, any number of such refractors could be included internal to the rod 10. In operation, as the light waves travel through the hollow core 29 of the rod 10, they strike the light refractors 52 and 53. A portion of the light waves travel through the light refractors 52 and 53, and a portion of the light waves are captured within the light refractor and directed towards the edges of the light refractor. As a result, a glowing ring of light appears at the location of the light refractors 52 and 53.

Advantageously, the embodiments of the invention illustrated in FIGS. 2a and 2b do not depend on the tapered characteristic of the rod 10 to provide the refraction of the light waves. Thus, in these embodiments of the present invention the light source can be present at various locations within the hollow core 29 of the rod. For instance, a single light source can be included in the tip end 16 of the rod 10 and the light waves directed towards the based end 12. In addition, one or more light sources can be included at various locations within the hollow core 29, directed with towards the tip end 16 or the base end 12.

Various other modifications or embodiments of the rod can also be employed. For instance, the entire rod 10 does not have to be translucent or transparent. Instead, portions of the rod 10 can be transparent or translucent and still achieve favorable results. For example, because the intensity of the light waves tends to be a little stronger closer to the light source, the intensity of the illumination effect may not be uniform over the length of the rod 10. This condition can be altered to change the light intensity pattern by the application of a coating or gradient pattern, such as by the application of a paint, to selected areas of the rod surface in proximity of the light source. Thus, the intensity of the illumination can be altered in a manner to provide a more uniform distribution. Furthermore, in some embodiments, it may not be desirable to have a uniform distribution of the illumination. For instance, it may be desirable to only illuminate the tip end 16 of the rod 10. The various embodiments of the present invention can also be utilized to satisfy this requirement. One such solution is to alter the translucent characteristics of the rod 10 so that the light waves only escape at the tip end 16 of the rod. Alternatively, this requirement can be satisfied by placing the light source at the tip end 16 of the rod 10 and only utilizing a single light refractor at or near the tip end 16.

It should also be appreciated that rather than relying on the refractive characteristics of the tapered hollow core 29 or the use of various refractors, a light wave conducting medium, such as a fiber optic cable can be placed internal to the rod 10. In this embodiment of the invention, the light wave conducting medium operates to carry the light waves throughout the length of the rod 10. The light wave conducting medium can be structured in a manner to provide similar refractive characteristics for the light waves as described in the other embodiments (i.e., tapered or including light refractors) although those skilled in the art will appreciate that other mechanisms could also be employed to provide refraction of the light waves.

Refractive characteristics can also be added or enhanced using other techniques, such as applying a phosphor coating to the surface of the hollow core 29, placing ridges or obstructions at various locations on the surface of the hollow core 29, and/or constructing the surface of the hollow core 29 to be rough, irregular or in other manners that will result in providing some refractive characteristics to light waves.

In yet another embodiment, the rod 10 can be fabricated as a solid rod of translucent material. In this embodiment, light waves can be directed through the solid rod from a light source. The light waves will be refracted as they exit the first medium, the rod 10, and enter the second medium the air surrounding the rod 10. Alternatively, the rod 10 can be fabricated with multiple materials, with each material having a different angle of incidence. For instance, the hollow core 29 could be replaced by a solid core of material having a different angle of incidence than the rod 10. In yet another embodiment, the rod 10 can be manufactured using two or more layers of material having differing angles of incidence.

It should be appreciated that similar performance can be obtained by placing multiple light sources through out the hollow core 29 of the rod 10. For instance, a string of mini light emitting diodes can be placed along the hollow core 29 of the rod. It should also be appreciated that any combination of the above-described techniques could be included in an embodiment of the invention. In addition, the various features or combination of features of the invention can be embodied in a single piece rod or a multi-piece rod.

In the various embodiments described herein, a light source is employed to provide illumination of the rod. As previously described, the light source can be located at various locations within the rod 10. In addition, it should be appreciated that the light source can be external to the rod 10 and then directed internal to the rod 10 to create a similar effect. The light source can be provided by various technologies but, the preferred embodiment of the present invention utilizes light emitting diodes (LEDs) or high-intensity LEDs. However, it will be appreciated by those skilled in the art that other technologies could also be employed including, but not limited to, laser technology, florescent technology, halogen technology and incandescent technology.

FIG. 3 is a diagram illustrating the provision of a light source in an embodiment in which the light source is located in the base end of the rod and directed towards the tip end of the rod. In this embodiment, a handle 14 is attached to the base end 12 of the rod 10. Portions of the interior of the handle 14 are hollow to accommodate the light source, as well as a power source in some embodiments. Thus, in one embodiment, the handle may be a tubular housing 22. In another embodiment, the handle may simply be a covering of the base end 12 of the rod and the light source is mounted within the base end 12. In either case, in the preferred embodiment the light source 24 is substantially centrally fixed within the handle. To provide directional control for the light waves, the light source can be mounted within a concave member 26, where the inner surface 28 is light reflective, such as electroplated nickel. Illumination from the light source, such as a high intensity LED, may be directed by the concave member down the hollow rod towards the rod's tip end 16.

The light source may be controlled by optics, circuitry, switches and a power source that are either co-located within the handle or that exist external to the rod 10. In the preferred embodiment illustrated in FIG. 3, the controlling elements are included within the handle.

To operate the light source 24, a source of power must be provided. In the various embodiments of the invention, the power source can be located internal to the rod or the handle, or exist externally. In the preferred embodiment illustrated in FIG. 3, an embedded power source is employed. The end of the tubular housing 22 opposite from the light source 24 is provided with a recessed lighting control mechanism 30. The recessed lighting control mechanism 30 includes a potentiometer 32 to control the current that is provided to the light source by the power source 31. Thus, the intensity of the illumination provided by the light source 24 can be controlled. Control of the potentiometer 32 is by means of a recessed rotary knob 34, within the recess 36, that further operates to control the potentiometer between an on and off position. The rotary knob 34 can be fixedly attached or removable. Specifically, by having the knob recessed, accidental activation of the knob is avoided in the event of one dropping or bumping the fishing rod.

The power source in the illustrated embodiment is provided by one or more dry cell batteries 31, such as conventional AA batteries, aligned in end-to-end relationship within the tubular housing 22. The batteries are preferably biased by spring members 38, 40. Those skilled in the art will appreciate that some circuitry may be necessary to properly power the light source from the power source, such circuitry may include various voltage dividers, driver circuitry, biasing circuitry and other circuitry or controls. Such circuitry is well known to those skilled in the art and the present invention is not limited to any particular circuitry used to provide the power source to the light source.

To complete the electrical circuit for operating the lighting control mechanism 30, a metal strip 42 lying adjacent the tubular housing wall 44, and metal ring 46 about and in communication with the potentiometer 32 is provided. The power is applied to the light source through leads 54 and 55.

In other embodiments wherein the light source is not located in the base end 12 of the rod 10, the power must still be provided to the light source 24. This can be accomplished in several manners, and for illustrative purposes only, examples are being provided. In one embodiment, wires, strips or other conductors can be installed in the hollow core 29 to carry the power supply to the light source 24. One disadvantage of this technique is realized in fishing rods that consist of two or more shafts that are interconnected. Such a configuration can result in damaging the wires when the rod is broken down for storage or preventing the breakdown of the rod altogether. This disadvantage can be overcome in another embodiment which utilizes traces, mounted on the internal surface of the hollow core 29 similar to the traces found on a circuit board. For multi-piece rods, the connection between the rods can be structured in such a manner to connect the traces from one rod section to the next without the risk of shorting the traces or leaving the connections open. It should also be appreciated that the present invention can be embodied in a single shaft rod as well as rods constructed of two or more interconnected shafts.

Various embodiments of the present invention have been described. Examples have been provided for descriptive purposes and the described examples should not be used to limit the scope of the present invention. It is recognized that changes, variations and modifications may be made to the various embodiments of the present invention without departing from the spirit and scope thereof.

1. A method for providing illumination dispersed over the length of a translucent fishing rod having a hollow core from a base end to a tip end, the method comprising the steps of:
providing a light source interior to the rod and located at one end of the rod; and
directing the light waves of the light source towards the opposite end of the rod through the hollow core.

2. The method of claim 1, wherein the hollow core is tapered from the base end to the tip end, and the step of providing a light source interior to the rod further comprises locating the light source at the base end of the rod, whereby the rod is illuminated by the light waves being refracted due to the tapered hollow core.

3. An illuminated fishing rod having a base end and a tip end, said fishing rod comprising:
a translucent rod having a hollow core; and
a light source generally located within the hollow core substantially near one end of the hollow core in such a manner as to direct the light waves toward the opposite end of the hollow core.

4. The illuminated fishing rod of claim 3, wherein the hollow core is tapered from the base end to the tip end and the light source is generally located within the hollow core substantially near the base end.

5. The illuminated fishing rod of claim 4, further comprising:
a power supply for powering said light source; and,
means for controlling the intensity of the light source.

6. The illuminated fishing rod of claim 5, wherein the rod includes a handle with an end portion and the means for controlling the intensity of the light source further comprises a potentiometer recessed within the end portion of the handle and operable to adjust the illumination intensity of the light source.

7. The illuminated fishing rod of claim 5, wherein the rod includes a handle with an end portion and the means for controlling the intensity of the light source further comprises a potentiometer recessed within the end portion of the handle and operable to adjust the illumination intensity of the light source at various levels between on and off.

8. The illuminated fishing rod of claim 4, wherein said light source is a light emitting diode.

9. The illuminated fishing rod of claim 8, wherein the light source is mounted within a reflective surface for focusing the light waves toward the tip end.

10. The illuminated fishing rod of claim 9, wherein the reflective surface is a concave member that includes a layer of electroplated nickel to concentrate the light waves within the hollow core.

11. The illuminated fishing rod of claim 3, wherein the translucent rod includes an opaque material covering portions of the translucent rod and thereby controlling the illumination of the translucent rod.

12. The illuminated fishing rod of claim 11, wherein opaque material is applied to the translucent rod in a manner to create a gradient pattern for the selective illumination of the rod.

13. The illuminated fishing rod of claim 3, further comprising a coating of phosphor applied to the surface of the hollow core.

14. The illuminated fishing rod of claim 3, wherein at least one light refractor is located within the hollow core and operates to refract the light waves external to the translucent rod.

15. The illuminated fishing rod of claim 14, wherein at least one light refractor is mounted within the hollow core at an angle.

16. The illuminated fishing rod of claim 14, wherein at least one light refractor is mounted within the hollow core substantially perpendicular to the walls of the hollow core.

17. The illuminated fishing rod of claim 3, wherein the translucent rod is substantially transparent.

18. The illuminated fishing rod of claim 3, wherein said translucent rod, in proximity to the light source, is partially coated with an opaque layer to provide a gradient pattern to form a semi-opaque layer.

19. An illuminated fishing rod having a base end and a tip end, the fishing rod comprising:
a translucent rod having a hollow core;
a light source generally located within the hollow core; and
a means for refracting the light waves from the light source in such a manner as to cause light waves to exit the translucent fishing rod, whereby the translucent fishing rod is illuminated.

20. The illuminated fishing rod of claim 19, wherein the light source is located at the base end and the means for refracting the light waves further comprises a hollow core that is tapered from the base end to the tip end.

21. The illuminated fishing rod of claim 19, wherein the means for refracting the light waves from the light source further comprises one or more refractors.

22. The illuminated fishing rod of claim 19, wherein the means for refracting the light waves further comprises a light wave conducting medium internal to the fishing rod, the light wave conducting medium having refractive characteristics to direct light waves traveling through the medium external to the rod.
